(19) United States
(12) Patent Application Publication
(10) Pub. No.: US 2021/0081651 A1
(43) Pub. Date: Mar. 18, 2021

(54) SYSTEM AND METHOD FOR PICTURE SHARING VIA ARTIFICIAL INTELLIGENCE

(71) Applicant: David Gorodyansky, Emerald Hills, CA (US)

(72) Inventor: David Gorodyansky, Emerald Hills, CA (US)

(21) Appl. No.: 17/013,860

(22) Filed: Sep. 8, 2020

Related U.S. Application Data
(60) Provisional application No. 62/900,851, filed on Sep. 16, 2019.

(51) Int. Cl. G06K 9/00; G06F 16/9035; G06F 16/9038

(52) U.S. Cl. CPC G06K 9/00268; G06F 16/9038; G06F 16/9035; G06K 9/00228

(57) ABSTRACT

An Artificial Intelligence system that may reside inside a mobile software application that uses the latest face recognition algorithms to organize photos on the phone in the picture gallery based on faces. It then analyzes photos in the phone contacts and matches the photos in the phone contacts with the photos in the picture gallery. When a match is detected, the photos are tagged with the phone number/contact from the phone contacts. This way photos on the phone are tagged with the phone number of the person in the photo. If there are multiple people in the picture, each person's face is tagged with their respective phone number. If there is no photo associated with a contact, then the user has the ability to tag the photo manually. Clicking on the tag option, pulls up the phone contact list and the user can only assign tags to photos from their contacts. The goal is to make sure every photo of every person in the photo gallery is tagged with a phone number, to enable artificial intelligence instead of humans to identify users in photos and to automatically share photos with the users identified, and the ability to enable smart search for users to find photos in their gallery based on the phone number of each person in their contracts list that the artificial intelligence system has tagged based on matching their photos in the gallery with their photos in their contact list.

### CROSS-REFERENCE TO RELATED PATENT APPLICATION

This regular U.S. patent application relies upon, claims the benefit of priority from U.S. provisional patent application No. 62/900,851, entitled “SYSTEM AND METHOD FOR PICTURE SHARING VIA ARTIFICIAL INTELLIGENCE,” filed on Sep. 16, 2019, which is incorporated by reference herein in its entirety.

### BACKGROUND OF THE INVENTION

### Field of the Invention

This invention generally relates to artificial intelligence that automates content sharing systems and methods and, more specifically, to a system and method for automatic picture sharing handled by artificial intelligence using face recognition.

### Description of the Related Art

Currently people have thousands of pictures of their friends, family, co-workers, etc on their phones, and their friends, family and co-workers have pictures of them. To share photos users have to manually select the photos they want to share and then post them to some public cloud like Facebook, Snapchat, Twitter, etc. Since people have thousands of photos on their phone it is hard to find photos to share and hard to share all photos with the exact people in those photos. For example: I went to Brazil with my 3 friends. Each of us has about 200 photos from that trip on our respective phones. We shared about 5 photos each on Facebook and send another 5 photos each to each other via What′sApp and SMS.

However, the rest of the photos of all of us together remain spread among our phones and none of us have seen most of the photos on the other's phones. Users don't want to post all their pictures to Facebook and other cloud services for privacy concerns, sending pictures via SMS or WhatsApp usually has a limit of photos (it's hard to send hundreds of photos by SMS or WhatsApp all at once). Also the process of finding the photos of each of your friends on your phone and sharing them with those specific friends is a manual and cumbersome process. The result is that thousands of photos of all of us are scattered around our friends phones and we have never seen these photos. There needs to be a way to automate picture discovery, identification of specific people in photos, and sharing. The invention described in detail below solves that problem.

### SUMMARY OF THE INVENTION

The inventive methodology is directed to methods and systems that substantially obviate one or more of the above and other problems associated with conventional techniques for automated picture sharing.

In accordance with one aspect of the invention, there is provided a A method comprising: automatically matching photos in a picture gallery of a mobile phone with photos in a contact list of a user via face recognition; and automatically tagging photos in the picture gallery with phone numbers from the mobile phone contact list, wherein each photo in the picture gallery of the mobile phone is provided with an identity and the face recognition, the phone number matching and tagging all happens locally on the mobile phone.

In one or more embodiments, once photos are tagged with phone numbers, sharing of the photos happens automatically.

In one or more embodiments, each user whose picture got tagged, gets a text message to the phone number which was tagged via the face recognition, saying “We found photos of you on your friend's phone, download the app to see them.”

In one or more embodiments, the tagged user is enabled to download a software application and receive the photos.

In one or more embodiments, the method further comprises providing settings that allow users to see all the photos at once or we may send the user photos in photo groups, where the user will receive a few photos every day over the course of a year.

In one or more embodiments, users are shown not all of their photos, but as many photos as they share themselves.

In one or more embodiments, once the user installs the app, the face recognition algorithms are performed on the mobile phone, photos and faces are matched with the photos and faces in the contacts list, photos are tagged with the user's phone numbers and automatically invite the user's friends to view them.

In one or more embodiments, once photos are grouped and tagged with phone numbers using face recognition on the mobile phone, they are automatically shared with the people in the photos.

In one or more embodiments, the photos are automatically discovered by: using face recognition performed on group photos, matching them with photos in the contact list; tagging photos with phone numbers; and automatically sharing the photos with the phone numbers tagged, wherein the users to automatically discover all photos of themselves on their friends phones without any effort from their friends. The sharing happens automatically via an Artificial Intelligence system that matches pictures with user contacts from the phone address book based on face recognition and then automatically shares the pictures with the users identified.

In one or more embodiments, the photos are not stored on any central server once the photos are downloaded to the users device.

In accordance with another aspect of the invention, there is provided a photo gallery of a mobile device, wherein photos in the photo gallery are automatically tagged with a contact from a contacts list of the mobile device and wherein sharing of the photos is performed automatically.

In one or more embodiments, a new search mechanism is enabled in the gallery that can search people by faces.

In one or more embodiments, to find a picture of a friend, a user is prompted to enter the friends' contact information the search field in the gallery and, in response, is provided with all their photos.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a computer/server system upon which an embodiment of the inventive methodology may be implemented.

### DETAILED DESCRIPTION

In the following detailed description, reference will be made to the accompanying drawing(s), in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on one or several general purpose computers, or smartphones or in the form of combination of software and hardware.

In accordance with one aspect of the embodiments described herein, there is provided a mobile software application with Artificial Intelligence that uses the latest face recognition algorithms to organize photos on the phone in the picture gallery based on faces. It then analyzes photos in the phone contacts and matches the photos in the phone contacts with the photos in the picture gallery. When a match is detected, the photos are tagged with the phone number/contact from the phone contacts. This way photos on the phone are tagged with the phone number of the person in the photo. If there are multiple people in the picture, each person's face is tagged with their respective phone number. If there is no photo associated with a contact, then the user has the ability to tag the photo manually. Clicking on the tag option, pulls up the phone contact list and the user can only assign tags to photos from their contacts. The goal is to make sure every photo of every person in the photo gallery is tagged with a phone number.

In one or more embodiments, photos in the picture gallery are matched with photos in the user's contact list via face recognition, and tagging photos in the picture gallery with phone numbers from the phone's contact list. This essentially provides an identity to each photo in the phone gallery. The face recognition, phone number matching and tagging all happens locally on the device.

In one or more embodiments, once photos are tagged with phone numbers, sharing of the photos happens automatically. Each user whose picture got tagged, get's a text message to the phone number which was tagged via the face recognition, saying “We found photos of you on your friend's phone, download the app to see them.” The user can download the app and receive the photos. We may have settings that allow users to see all the photos at once or we may send the user photos in photo groups, where the user will receive a few photos every day over the course of a year for example. We may also show users not all of their photos, but as many photos as they share themselves. Once the user installs the app, the inventive Artificial Intelligence technology will run the face recognition algorithms on the device, match photos and faces with the photos and faces in the contacts list, tag photos with the user's phone numbers and automatically invite the user's friends to view them.

In one or more embodiments, once photos are grouped and tagged with phone numbers using face recognition on the device, they are automatically shared with the people whose faces appeared in the photos. The Artificial Intelligence system shares the photos, and there is no manual sharing that's done by the users.

In one or more embodiments, the described system creates an automated way for photos to be discovered by using face recognition to group photos, match them with photos in the contact list, tag photos with phone numbers, and automatically share the photos with the phone numbers tagged. This creates a powerful way for users to discover all photos of themselves on their friends phones without any effort from their friends. The whole process is automated by the Artificial Intelligence system. Essentially identification and sharing of photos is outsourced from humans to the Artificial Intelligence system.

In one or more embodiments, the described system replaces the default photo gallery where photos have no identity and are hard to manually share, with the inventive way of matching photos with contacts, tagging them with phone numbers, and automatically sharing them. We believe we can create a new phone gallery where identifying and sharing photos is automated by the inventive Artificial Intelligence system. Doing this locally on the device without hosting any files on our servers is key to privacy. All photos will be end to end encrypted. Our servers will only be required to pass through the photos, however, they will not store the photos once the photos are downloaded to the users device. This essentially will be a social network of phone picture galleries automatically sharing pictures with one another, in a privacy conscious way, without any cloud storage of photos.

In one or more embodiments, there is provided a new photo gallery where photos are tagged with a contact from the contacts list and where sharing happens automatically. And enabling a new search mechanism in the gallery that can search people by faces. To find a picture of a friend, just enter the friends contact into the search field in the gallery and see all their photos.

### Exemplary Computer Platform

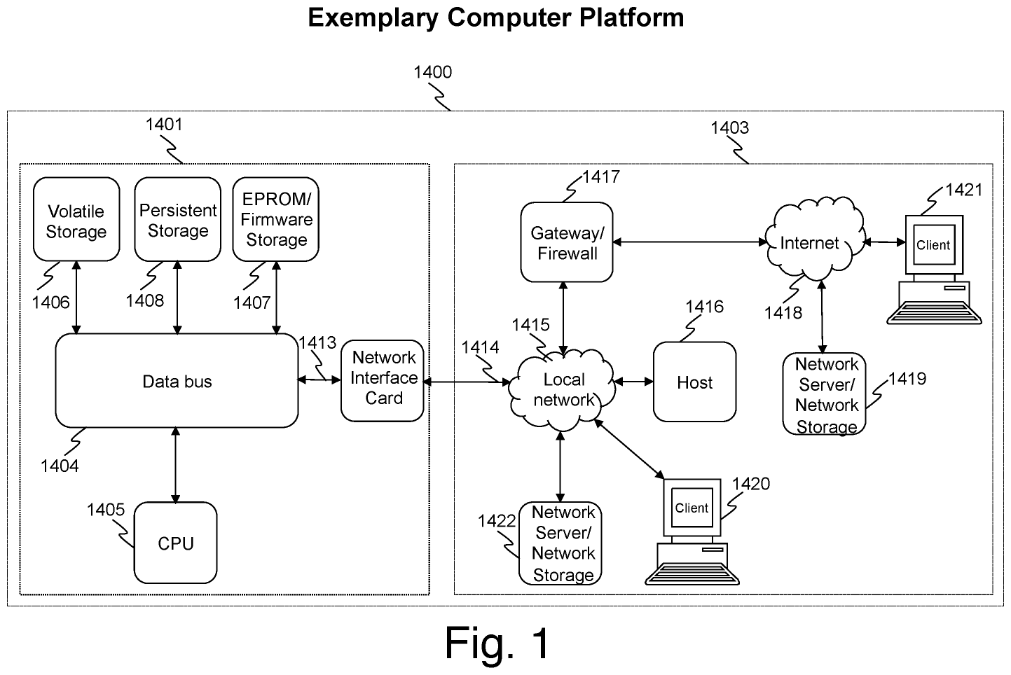

FIG. 1 is a block diagram that illustrates an embodiment of a computer/server system 1400 upon which an embodiment of the inventive methodology may be implemented. The system 1400 includes a computer/server platform 1401 and network resources 1403.

The computer platform 1401 may include a data base 1404 or other communication mechanism for communicating information across and among various parts of the computer platform 1401, and a processor 1405 coupled with bus 1401 for processing information and performing other computational and control tasks. Computer platform 1401 also includes a volatile storage 1406, such as a random access memory (RAM) or other dynamic storage device, coupled to bus 1404 for storing various information as well as instructions to be executed by processor 1405. The volatile storage 1406 also may be used for storing temporary variables or other intermediate information during execution of instructions by processor 1405. Computer platform 1401 may further include a read only memory (ROM or EPROM) 1407 or other static storage device coupled to bus 1404 for storing static information and instructions for processor 1405, such as basic input-output system (BIOS), as well as various system configuration parameters. A persistent storage device 1408, such as a magnetic disk, optical disk, or solid-state flash memory device is provided and coupled to bus 1401 for storing information and instructions.

An external storage device 1412 may be connected to the computer platform 1401 via bus 1404 to provide an extra or removable storage capacity for the computer platform 1401. In an embodiment of the computer system 1400, the external removable storage device 1412 may be used to facilitate exchange of data with other computer systems.

The invention is related to the use of computer system 1400 for implementing the techniques described herein. In an embodiment, the inventive system may reside on one or multiple machines such as computer platform 1401. According to one embodiment of the invention, the techniques described herein are performed by computer system 1400 in response to processor 1405 executing one or more sequences of one or more instructions contained in the volatile memory 1406. Such instructions may be read into volatile memory 1406 from another computer-readable medium, such as persistent storage device 1408. Execution of the sequences of instructions contained in the volatile memory 1406 causes processor 1405 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1405 for execution. The computer-readable medium is just one example of a machine-readable medium, which may carry instructions for implementing any of the methods and/or techniques described herein. Such a medium may take many forms, including but not limited to, non-volatile media or volatile media. Non-volatile media includes, for example, optical or magnetic disks, such as storage device 1408. Volatile media includes dynamic memory, such as volatile storage 1406.

Common forms of computer-readable media include, for example, a floppy disk, a flexible disk, hard disk, magnetic tape, or any other magnetic medium, a CD-ROM, any other optical medium, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 1405 for execution. For example, the instructions may initially be carried on a magnetic disk from a remote computer. Alternatively, a remote computer can load the instructions into its dynamic memory and use an infra-red transmitter to convert the data to an infra-red signal. An infra-red detector local to computer system 1400 can receive the data carried in the infra-red signal and appropriate circuitry can place the data on the data bus 1404. The bus 1404 carries the data to the volatile storage 1406, from which processor 1405 retrieves and executes the instructions. The instructions received by the volatile memory 1406 may optionally be stored on persistent storage device 1408 either before or after execution by processor 1405. The instructions may also be downloaded into the computer platform 1401 via Internet using a variety of network data communication protocols well known in the art.

The computer platform 1401 also includes a communication interface, such as network interface card 1413 coupled to the data bus 1404. Communication interface 1413 provides a two-way data communication coupling to a network link 1414 that is connected to a local network 1415. For example, communication interface 1413 may be an integrated services digital network (ISDN) card or a modem to provide a data communication connection to a corresponding type of telephone line. As another example, communication interface 1413 may be a local area network interface card (LAN NIC) to provide a data communication connection to a compatible LAN. Wireless links, such as well-known 802.11a, 802.11b, 802.11g, 802.11n, 802.11ac, and Bluetooth may also be used for network implementation. In embedded avionics implementations of the network, one of the standard backplane data buses such as, ARINC 629 or an optical avionics data bus may be used. A TTP data bus may also be used, such as in automotive and aerospace applications. In any such implementation, communication interface 1413 sends and receives electrical, electromagnetic or optical signals that carry digital data streams representing various types of information.

Network link 1413 typically provides data communication through one or more networks to other network resources. For example, network link 1414 may provide a connection through local network 1415 to a host computer 1416, or a network storage/server 1417. Additionally or alternatively, the network link 1413 may connect through gateway/firewall 1417 to the wide-area or global network 1418, such as an Internet. Thus, the computer platform 1401 can access network resources located anywhere on the Internet 1418, such as a remote network storage/server 1419. On the other hand, the computer platform 1401 may also be accessed by clients located anywhere on the local network 1415 and/or the Internet 1418. The network clients 1420 and 921 may themselves be implemented based on the computer platform similar to the platform 1401.

Local network 1415 and the Internet 1418 both use electrical, electromagnetic or optical signals that carry digital data streams. The signals through the various networks and the signals on network link 1414 and through communication interface 1413, which carry the digital data to and from computer platform 1401, are exemplary forms of carrier waves transporting the information.

Computer platform 1401 can send messages and receive data, including program code, through the variety of network(s) including Internet 1418 and local network 1415, network link 1414 and communication interface 1413. In the Internet example, when the system 1401 acts as a network server, it might transmit a requested code or data for an application program running on client(s) 1420 and/or 1421 through Internet 1418, gateway/firewall 1417, local network 1415 and communication interface 1413. Similarly, it may receive code from other network resources.

The received code may be executed by processor 1405 as it is received, and/or stored in persistent or volatile storage devices 1408 and 1406, respectively, or other non-volatile storage for later execution. In this manner, computer system 1401 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, VHDL, C/C++, C#, SQL, Java, Matlab/Simulink, R, Labview, python, perl, ruby, shell scripts, etc.

Moreover, other implementations of the invention will be apparent to those skilled in the art from consideration of the specification and practice of the invention disclosed herein. Various aspects and/or components of the described embodiments may be used singly or in any combination in the inventive system for photo sharing. It is intended that the specification and examples be considered as exemplary only, with a true scope and spirit of the invention being indicated by the following claims.

What is claimed is:

1. An Artificial Intelligence system comprising:
a. automatically matching photos in a picture gallery of a mobile phone with photos in a contact list of a user via face recognition; and
b. automatically tagging photos in the picture gallery with phone numbers from the mobile phone contact list, wherein each photo in the picture gallery of the mobile phone is provided with an identity via the face recognition used by the Artificial Intelligence system, the phone number matching and tagging all happens locally on the mobile phone.

2. The method of claim 1, wherein once photos are tagged with phone numbers, sharing of the photos happens automatically via the inventive Artificial Intelligence system.

3. The method of claim 1, wherein the Artificial Intelligence system automatically sends each user whose picture got tagged, a text message to the phone number which was tagged via the face recognition, saying “We found photos of you on your friend's phone, download the app to see them.”

4. The method of claim 1, wherein the tagged user is enabled to download a software application and receive the photos.

5. The method of claim 1, wherein the method further comprises providing settings that allow users to see all the photos at once or we may send the user photos in photo groups, where the user will receive a few photos every day over the course of a year for example.

6. The method of claim 1, wherein users are shown not all of their photos, but as many photos as they share themselves.

7. The method of claim 1, wherein once the user installs the app, the face recognition algorithms are performed on the mobile phone, photos and faces are matched with the photos and faces in the contacts list, photos are tagged with the user's phone numbers and automatically invite the user's friends to view them.

8. The method of claim 1, wherein once photos are grouped and tagged with phone numbers using face recognition on the mobile phone, they are automatically shared with the people in the photos.

9. The method of claim 1, wherein the photos are automatically discovered by:
a. using face recognition performed on group photos, matching them with photos in the contact list;
b. tagging photos with phone numbers; and
c. automatically sharing the photos with the phone numbers tagged, wherein the users to automatically discover all photos of themselves on their friends phones without any effort from their friends.
d. Where identifying and sharing of photos is done automatically via the inventive Artificial Intelligence system instead of by humans.

10. The method of claim 1, wherein the photos are not stored once the photos are downloaded to the users device.

11. A new photo gallery of a mobile device, wherein photos in the photo gallery are automatically tagged with a contact from a contacts list of the mobile device and wherein sharing of the photos is performed automatically.

12. The method of claim 11, wherein a new search mechanism is enabled in the gallery that can search people by faces via their contact names and phone numbers.

13. The method of claim 12, wherein to find a picture of a friend, a user is prompted to enter the friends contact into the search field in the gallery and, in response, is provided with all their photos.
